(19) United States
(12) Patent Application Publication
(10) Pub. No.: US 2014/0288962 A1
(43) Pub. Date: Sep. 25, 2014

(54) Multi-Media Medical Notes System (MMMNS)

(71) Applicants: Jacob Roman Krzanowski, White Plains, NY (US); Roman Maria Krzanowski, White Plains, NY (US)

(72) Inventors: Jacob Roman Krzanowski, White Plains, NY (US); Roman Maria Krzanowski, White Plains, NY (US)

(21) Appl. No.: 13/720,784

(22) Filed: Mar. 20, 2013

(51) Int. Cl. G06F 19/00

(52) U.S. Cl. CPC G06F 19/327
USPC 705/3

(57) ABSTRACT

This invention develops a Multi-Media Medical Notes System (MMMNS) that allows for the creation of the medical notes and integration with the medical records data bases. Its purpose is to provide an electronic format where the notes created during a patient's admission regarding daily examinations normally noted in analogue form could be organized to improve their presentation, accessibility, and integration. MMMNS system provides the integration and accessibility of all forms of medical notation such as operation notes, radiologist's reports, discharge letters, admission reports and interpretation of lab and examination results. In addition it expands the medical notes to include any type of record available, such as but not limited to, typed notes, handwritten notes, videos clips, radiographic imaging modalities (CT, PET, MRI, USG, Xray), still photographs, scanned bar cods or ID tags, GPS data, remote sense data is available, voice recording clips.

### BACKGROUND INFORMATION

It is a normal operating procedure in hospitals and other points of delivery of medical services that the attending medical personnel (primary doctor, referring clinicians, nurses, nutritionist, physical therapist, occupational therapist etc.) take quick notes during the course of a patient's admission to track the day to day events in a patient's ongoing care. These notes include but are not limited to, the place/date/time, identity/job title/contact of the author and notation summarizing the author's encounter/intervention with the patient.

Moreover these notes not only form a record of a patient's admission they are also used as a mean of communicating and coordinating a successful healthcare plan between the various teams involved.

currently the notes are most often hand written on paper format in the patients personal set of notes.

Over the of course of the patient' care several notes may be accumulated from different sources. They are usually collected in the document folders of the patient. In the context of a busy healthcare setting these notes are often illegible and fail to give basic information essential to each note.

Moreover their current format makes it difficult to locate specific notes, review the items as a set, collect them together and relate to other data bases containing the patient's medical records. Finally, these notes often form the only copy of the information they contain.

### BRIEF DESCRIPTION OF THE DRAWINGS

FIG. 1 illustrates the exemplary architecture of the preferred embodiment of the Multi-Media Medical Notes System.

FIG. 2 illustrates the exemplary architecture of the input methods of the preferred embodiment of the Multi-Media Medical Notes System.

FIG. 3 illustrates the exemplary flow diagram of information between the input devices and the Multi-Media Medical Notes System processing system.

FIG. 4 illustrates the exemplary flow diagram of information between the input devices and the Multi-Media Medical Notes System processing system and the patient records system.

FIG. 5 illustrates the exemplary flow diagram of information between the Multi-Media Medical Notes System processing system and the patient records system.

### DETAILED DESCRIPTION OF THE PREFERRED EMBODIMENT

The following detailed description refers to the accompanying drawings. The same reference numbers in different drawings may identify the same or similar elements.

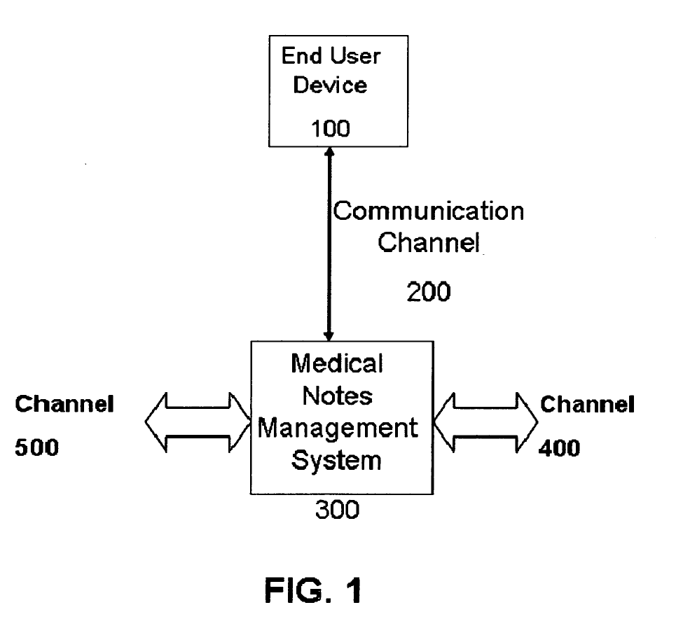

FIG. 1 shows components of one implementation of the Multi-Media Medical Notes System (MMMNS) referred to in the following text as MMMNS. The MMMNS in one implementation consists of Multi-Media Medical Notes Management System Processing System (MMMN-PS) 300, The End User Device (100) referred to from now on as EUD. The communication channel (200) between MMNS-PS and EUD. The communication channel (400). The communication channel (600).

In one implementation of the MMMNS, the MMMNS works in the following way. The user of the MMMNS using an EUD inputs the information into the EUD. The EUD sends digitally encoded information into the MMMN-PS using the channel 200. The MMMNS receives this information. The MMMN-PS may store this information, process depending on the type of information and user's request, aggregate, select information based on the combination of indices. The MMMN-PS may communicate using channel 400 or channel 600 with other systems exchanging information about the stored information received from the EUD. The EUD at one point may request the information from the MMMN-PS. The MMMN-PS sends over the channel 200 the response to the request from the EUD.

The EUD may be any type of device comprising software and hardware components capable of input, output, storage and transmission of the electronically encoded information using any type of media and any type of communication channel or communication protocol.

The EUD device in one implementation may be capable of input, output, storage and transmission of textual, visual, image, voice, video, scan, any other form of electric information.

The EUD device in one implementation is also able to support search, query, and any other type of information processing and manipulation on stored or retrieved information.

The communication channel 200 is implemented with any type of wireless or wireline technology capable of supporting the exchange of electronic information between communication devices. The Channel 200 supports the communication using network layers of the standard networking layer model comprising physical, link, data, and higher networking protocol layers or any derived or similar embodiments of the networking protocols resulting from merging or collapsing of networking layers. The communication channel supports the secure information exchange. The security of information exchange is provided by the standard or custom security methods.

The communication channel 400 is implemented with any type of wireless or wireline technology capable of supporting the exchange of electronic information between communication devices. The Channel 400 supports the communication using network layers of the standard networking layer model comprising physical, link, data, and higher networking protocol layers or any derived or similar embodiments of the networking protocols resulting from merging or collapsing of networking layers. The communication channel supports the secure information exchange. The security of information exchange is provided by the standard or custom security methods.

The communication channel 600 is implemented with any type of wireless or wireline technology capable of supporting the exchange of electronic information between communication devices. The Channel 600 supports the communication using network layers of the standard networking layer model comprising physical, link, data, and higher networking protocol layers or any derived or similar embodiments of the networking protocols resulting from merging or collapsing of networking layers. The communication channel supports the secure information exchange. The security of information exchange is provided by the standard or custom security methods.

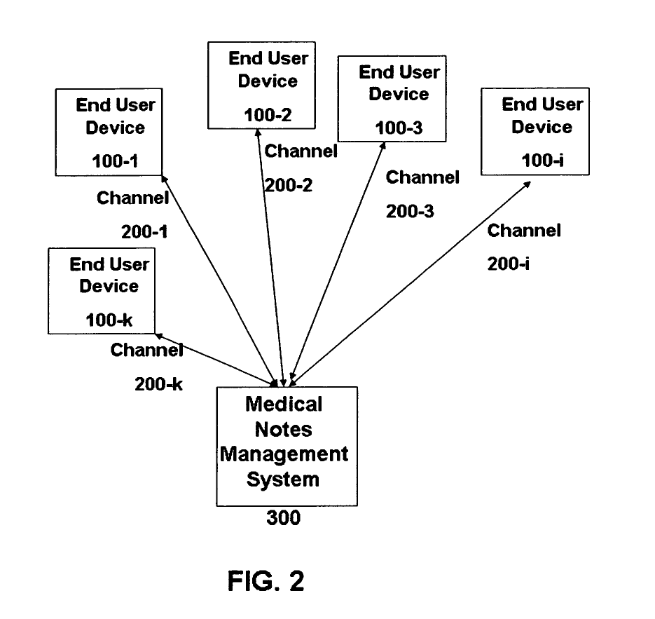

FIG. 2 shows an exemplary configuration of the MMMNS system in which multiple EUD devices (100-1, 100-2, 100-3, 100-i, 100-k) communicate with the MMMNS-PS over communication channels (200-1, 200-2, 200-3, 200-i, 200-k). The number of EUD communicating with the MMMNS and related communication channels Is not limited to the preferred embodiment shown on FIG. 2. Functions of the EUD devices and communication channels are described in [013, 014,015,016,017].

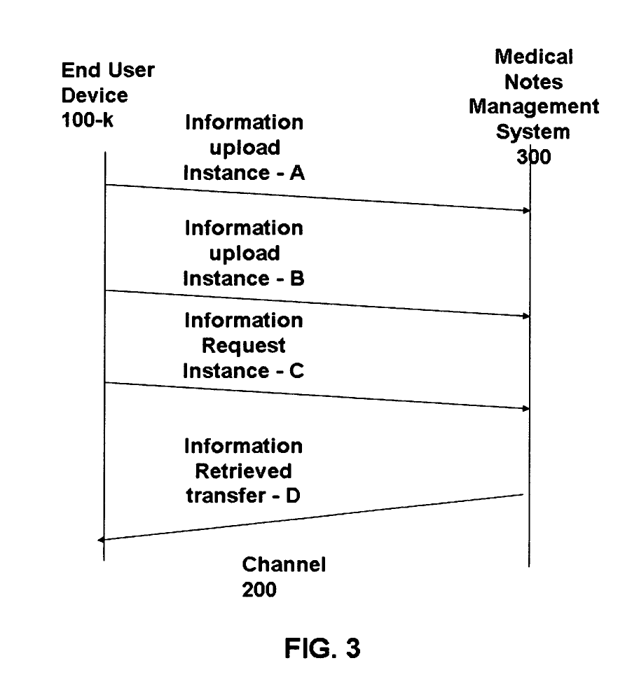

FIG. 3 shows an exemplary flow of information between an EUD device and the MMMN-PS. The information flow is comprised from translations between an EUD and the MMMNS-PS. The transition may be the exchange of data items, or request for the specific data item.

The data items may include indexing fields, have different information, content, scope, may even be of different format—textual, visual, image, voice, video, scan, any other form of electric information storage would be regarded as permissible data item.

The data items are indexed by several indices. The said Indexes may include but are not limited to: Date, Time, GPS location, Location, Patient's id/name, Medical personnel's ID, name, job title, machine generated patient's number. Indexes are uniquely identifying each stored item with respect to the time, location, patient, doctor entering the item, and other relevant information pertinent. An index may be any unique combination of characters, special characters and numbers or any other signs that can be recognized by the digital device.

In one embodiment the following information may be considered as data item: Place/Date/time/place; Person entering note; patient: hand written note—“Sent to MRI”

In another embodiment the following information may be considered as data item Place/date/time; Person entering note; patient: typed note: “took temperature, took vital signs, discussed with Dr. X the next procedure . . . etc”

In another embodiment the following information may be considered as data item Place/Date/time; Person entering note; patient: voice note on the procedure xxx

In another embodiment the following information may be considered as data item Place/Date/time; Person entering note; patient: video clip of the patient

In another embodiment the following information may be considered as data item Place/Date/time; Person entering note; patient: GPS recording of the patient's location

In another embodiment the following information may be considered as data item Place/Date/time; Person entering note; patient: bar code scan of the medication administered

In another embodiment the following information may be considered as data item Place/Date/time; Person entering note; patient: voice recording of the conversation with the patient

In another embodiment the following information may be considered as data item Place/Date/time; Person entering note; patient: A note from the consultation with the supervising physician

In another embodiment the following information may be considered as data item Place/Date/time; Person entering note; patient: Asked to see patient regarding hypoglycemia. Patient awake in bed and in no acute distress. Vitals: cardiovascular stable, apyrexic, RR 14 and SO2 98 on room air. Impression: pt with hypoglycemia non symptomatic. Plan: repeat glucose check 2. If less then 70 mg/dl give sugar 3. if patient becomes symptomatic please contact at bleep 1234

In another embodiment the following information may be considered as data item Place/Date/time; Person entering note; patient: Ward Round with Dr. John

In another embodiment the following information may be considered as data item Patient post operative day 5 right sided arthroplasty. At bedside patient sitting up and reading. Good mood and affect. Vitals and examination: obs stable, wound dry, minimal signs of inflammation. Patient is mobile and eating and drinking by mouth. Plan: discharge patient today with pain relief and follow up appointment.

Examples [024] to [034] illustrate only exemplary information that can be processed by the MMMNS. The MMMNS is designed to process any type of information related to the patient's medical history not in any way limited, constrained, or defined in form and content by Examples [024] to [034]. In general, the information processed by the MMMNS contains two parts:

INDEX as defined in [0023]

Data as illustrated in exemplar embodiments in [024] to [035]

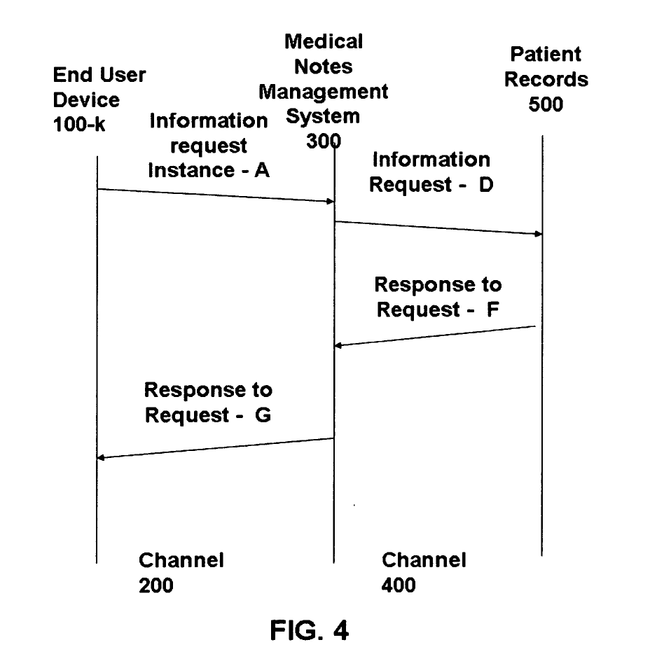

FIG. 4 shows the information flow between the MMMNS system and the Patients' data records system [500]. The information flow is supported by the communication channels 200 and 400 defined in [017] and [018].

In the exemplary implementation FIG. 4 illustrates the translation in which an EUD requests the specific information from the MMMN-PS [information request instance A]. The MMMN-PS requests the related data from the Patients' data records system [500] [information request instance B]. The Patients' data records system [500] responds with [information request instance B]. The MMMN-PS send the response to the EUD with [information request instance d].

The information exchange between systems in [037] may contain but is not limited to the data items listed in Examples [024] to [034] and additional qualified in [035]

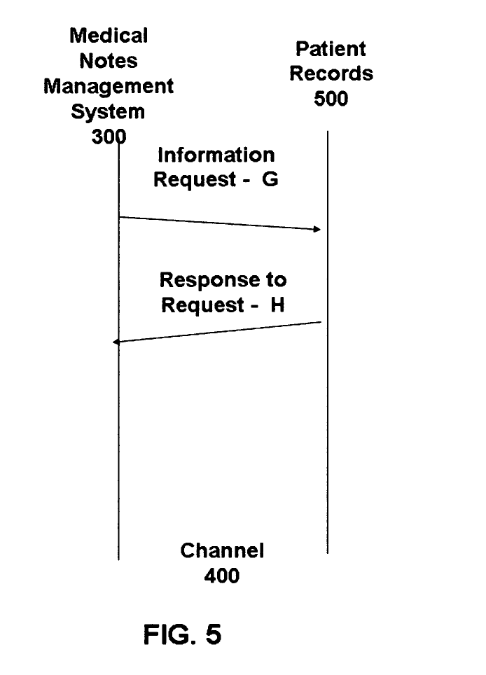

FIG. 5 shows the information flow between the MMMN-PS system and any Patients' data records system [500]. The information flow is supported by the communication channel 400 defined in [018].

In the exemplary implementation FIG. 5 illustrates the translation in which the MMMN-PS [information request instance G] requests the data from the Patients' data records system [500]. The Patients' data records system [500] responds with [information request instance H].

The information exchange between systems in [037] may contain but is not limited to the data items listed in Examples [024] to [034] and additional qualified in [035].

The channel 600 in FIG. 1 supports the information exchange between the MMMNS with any system capable of information exchange.

What is claimed is:

1. A Method comprising:
Multi-Media Medical Notes System (MMMNS) system capable of input of different media information—data item—about the patient, and;
indexing each stored data item by several indices. The said Indexes may include but are not limited to: Date, Time, GPS location, Location, Patient's id/name, Medical personnel's ID, name, job title. Machine generated string of signs. An index may be any unique combination of characters, special characters and numbers or any other signs that can be recognized by the digital device.

2. The method of claim 1, further comprising
exemplary medical information can be but is not limited to the following general examples:
(Example 1) Place/Date/time/place; Person entering note; patient: hand written note—“Sent to MRI”
(Example 2) Place/date/time; Person entering note; patient: typed note: “took temperature, took vital signs, discussed with Dr. X the next procedure . . . etc”
(Example 3) Place/Date/time; Person entering note; patient: voice note on the procedure xxx
(Example 4) Place/Date/time; Person entering note; patient: video clip of the patient
(Example 5) Place/Date/time; Person entering note; patient: GPS recording of the patient's location
(Example 6) Place/Date/time; Person entering note; patient: bar code scan of the medication administered
(Example 7) Place/Date/time; Person entering note; patient: voice recording of the conversation with the patient
(Example 8) Place/Date/time; Person entering note; patient: A note from the consultation with the supervising physician
(Example 9) Place/Date/time; Person entering note; patient: Asked to see patient regarding hypoglycemia. Patient awake in bed and in no acute distress. Vitals:
cardiovascular stable, apyrexic, RR 14 and SO2 98 on room air. Impression: pt with hypoglycemia non symptomatic. Plan: repeat glucose check 2. If less then 70 mg/dl give sugar 3. if patient becomes symptomatic please contact at bleep 1234
(Example 10) Place/Date/time; Person entering note; patient: Ward Round with Dr. John
(Example 11) Patient post operative day 5 right sided arthroplasty. At bedside patient sitting up and reading. Good mood and affect. Vitals and examination: obs stable, wound dry, minimal signs of inflammation. Patient is mobile and eating and drinking by mouth. Plan: discharge patient today with pain relief and follow up appointment. Examples 1 to 11 illustrate exemplary information that can be processed by the MMMNS. The MMMNS is designed to process any type of information related to the patient's medical history not in any way limited to the content and form illustrated in Examples 1 to 11. In general information that can be processed by the MMMNS is comprised from the index or a set of indexes and the data portion containing the patient's related information of any type that can be processed by the digital device.

3. The method of claim 1, further comprising:
data items stored in the proposed system may be different from those in claim 2 in the form, content; and
the data items may include indexing fields, have different information, content, scope, may even be of different format—textual, visual, image, voice, video, scan, any other form of electric information storage would be regarded as permissible data item.

4. The method of claim 1, further comprising:
each individual data item is independently indexed, searchable and retrievable on the full or partial index in the said MMMNSS system; and
each item entry has associated meta-information about the record such as but not limited to:
a. Recording device
b. Wireless/wireline connection information (time/date/send receive, protocol, in,out/port, MAC address, IP address

5. The method of claim 1, further comprising;
be capable of electronic transmission of this information to the central data base, and would be capable of storing each received data in the database

6. The method of claim 1, further comprising;
be able to respond to the queries on the indexed data and retrieve and present the request data, if it exists; and
be able to accommodate any type of media—including but not limited to typed notes, handwritten notes, videos clips, still photographs, scanned bar codes or ID tags, GPS data, remote sense data is available, voice recording clips recorded by the medical personal; and
will be capable of linking the medical notes to the other medical data bases, including past medical records.

7. The method of claim 1, further comprising;
be capable of being implemented on any dedicated or general use device (the devices are for example but not limited to tablets, notebooks, intelligent/smart phones, laptops, desktops, wireless devices with required capabilities, and similar) supporting all or a subset of necessary functions; and
be capable of automated uploading and synchronization with the said software system data base; and
all transactions and operations performed on/by the said MMMNS system are secure and secured using the industry accepted security standards and methods at the time of the system deployment and use; and
records any changes to the recorded information permanently allowing to track any changes in records; and
all changes are indexed as the main entries
